(19) United States
(12) Patent Application Publication
(10) Pub. No.: US 2009/0016384 A1
(43) Pub. Date: Jan. 15, 2009

(54) Method and apparatus for distributing synchronization status messages over a Resilient Packet Ring (RPR)

(75) Inventors: Weiying Cheng, Naperville, IL (US); Chris R. Zettinger, Wheaton, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/827,545

(22) Filed: Jul. 12, 2007

(51) Int. Cl. H04J 3/06; H04J 1/16

(52) U.S. Cl. 370/512; 370/222; 370/252

(57) ABSTRACT

Packets used for distributing timing information over a Resilient Packet Ring (RPR) are generated by encoding Synchronization Status Messaging (SSM) messages into IEEE 802.3ah OAM packets (or any other OAM packets, such as those defined in ITU Y.1731). Information indicating the direction that each message is to be transmitted around the RPR ring is also encoded in the packets in either the spare bits of the SSM messages or in the Type-Length-Value (TLV) bytes of the IEEE 802.3ah OAM packets or Y.1731 OAM packets. RPR protection is disabled for the packets carrying the SSM messages and the packets are transmitted to adjacent network nodes in the directions specified by the information encoded in the messages. Information encoded in received packets specifying timing quality and direction of the received messages is observed and compared to determine which timing information included in the messages to use for clock timing.

### BACKGROUND OF THE INVENTION

Network elements in a synchronous network may use several sources as synchronization references (e.g., external timing sources, terminating line signals, or an internal clock). Synchronization Status Messaging (SSM) allows a network, such as a Synchronous Optical Network (SONET), to manage the distribution of timing in synchronous networks. It provides a mechanism for downstream nodes of the network to determine the traceability of the synchronization distribution scheme back to a primary reference clock or highest quality clock that is available. In SONET networks, the messages are sent in SONET signals via the SI overhead byte and communicate clock quality information so that network elements within the synchronous network can select the most suitable synchronization reference available in the network and can avoid timing loops.

### SUMMARY OF THE INVENTION

According to one example embodiment of the present invention, a node in a protection packet ring network includes a packet generation module that generates packets with information embedded in the packets. The information is relevant to both selection of timing and selection of an interface to a physical link. The node also includes a transmission module that transmits the packets via respective interfaces to adjacent nodes on the protection packet ring.

According to another example embodiment, a node in a protection packet ring network includes an observation module that observes information embedded in packets received from other nodes. The information identifies interfaces to physical links of the other nodes from which the packets were received. The node also includes a comparison module that compares the information of the packets to select which timing information included in the packets to use for clock timing in the node.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating a Resilient Packet Ring (RPR) network having four nodes.

FIG. 2 is a diagram illustrating a Synchronization Status Messaging (SSM) message format.

FIG. 3 is a network diagram illustrating distributing timing in an RPR network.

FIG. 4 is a network diagram illustrating distributing timing in an RPR network with a break along a path between two of the network nodes.

FIG. 5A is a block diagram illustrating interfaces of nodes along a path in an Ethernet network.

FIG. 5B is a block diagram illustrating interfaces of RPR nodes along paths in an RPR network.

FIG. 6 is a detailed block diagram illustrating a network node in a synchronous RPR network.

FIG. 7 is a flow diagram illustrating generating, transmitting, observing, and comparing of timing information in a synchronous RPR network.

FIGS. 8A and 8B are detailed flow diagrams illustrating generating and transmitting timing messages in a synchronous RPR network.

FIGS. 9A and 9B are detailed flow diagrams illustrating observing and comparing timing information in a synchronous RPR network.

### DETAILED DESCRIPTION OF THE INVENTION

A description of example embodiments of the invention follows.

Ethernet was originally designed to handle asynchronous data (i.e., data that does not require a synchronous network); however, newer applications, such as the transport of circuit emulation services, video distribution, and the distribution of synchronization over packet networks, require a synchronous Ethernet network.

Typically, a TDM circuit service provider maintains a timing distribution network, providing synchronization traceable to a primary reference clock. While synchronization in existing TDM networks, such as SONET networks, is well understood and implemented, the nodes involved in typical packet-oriented transmission technology (e.g., ATM network nodes) do not require any synchronization capabilities for packet switching. As packet networks begin to integrate TDM-based applications, however, packet networks need to provide correct timing at traffic interfaces.

Implementing a synchronous Ethernet involves distributing synchronization status messages between nodes in the network for timing reference switching or selection. To accomplish this, the International Telecommunication Union (ITU) recommends in G.8261 encoding Synchronization Status Messaging (SSM) messages into a type of message standardized by the Institute of Electrical and Electronics Engineers (IEEE). That type of standardized message is an IEEE 802.3ah Operations Administration and Maintenance (OAM) message, also known as Ethernet in the First Mile.

Since IEEE 802.3ah is applicable only to point-to-point single hop links; it is not applicable to ring topologies. There is, therefore, no current way to distribute SSM messages over Resilient Packet Ring (RPR) networks. Accordingly, a method to distribute IEEE 802.3ah OAM based SSM messages over an RPR network is desired.

According to one example embodiment of the present invention, a node in a protection packet ring network includes a packet generation module that generates packets with information embedded in the packets. The information is relevant to both selection of timing and an interface to a physical link. The node also includes a transmission module that transmits the packets via respective interfaces to adjacent nodes on the protection packet ring.

The node may also include an observation module that observes information embedded in other packets identifying interfaces to physical links of the adjacent nodes from which the other packets were received, and may also include a comparison module that compares the information of the other packets to select which timing information included in the packets to use for clock timing in the node.

The information may include a direction indicator and a timing quality indicator, an interface identifier and a timing quality indicator, a station identifier and a timing quality indicator, or Synchronization Status Messaging (SSM) information, and may be embedded in an overhead section of the packets. Additionally, the transmission module may determine on which interfaces to transmit the packets by accessing a table associated with a protection layer. The transmission module also may disable transmission of packets via a protection path associated with a faulty physical link.

According to another example embodiment, a node in a protection packet ring network includes an observation module that observes information embedded in packets received from other nodes. The information of the packets identifies interfaces to physical links of the other nodes from which the packets were received. The node also includes a comparison module that compares the information of the packets to select which timing information included in the packets to use for clock timing in the node. Additionally, the observation module may remove Resilient Packet Ring (RPR) identifiers from the packets.

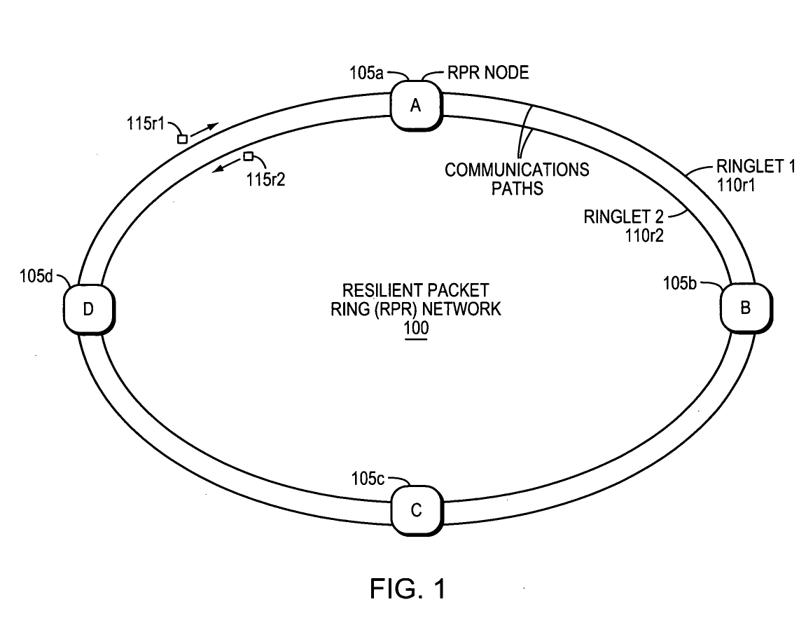

FIG. 1 is a network diagram illustrating a Resilient Packet Ring (RPR) network (“RPR ring”) 100, also referred to herein simply as a “ring.” The ring 100 has four nodes 105a-d coupled by two counter-rotating communications paths in this example, Ringlet 1 110r1 and Ringlet 2 110r2. Traffic 115r1 on Ringlet 1 110r1 travels clockwise around the ringlet 110r1, and traffic 115r2 on Ringlet 2 110r2 travels counter-clockwise around the ringlet 110r2. The terms “traffic” and “communications” are synonymous as used herein. The term “traffic” may include packets or frames, which are also synonymous as used herein.

Resilient Packet Ring (RPR) in noun form refers to a ring-based network protocol that supports bridging to other network protocols, such as Ethernet. Today's RPR uses 48-bit source and destination Media Access Control (MAC) addresses in the same format as Ethernet. When an Ethernet frame is bridged onto an RPR ring, an RPR station on the ring encapsulates the Ethernet frame with an RPR header in an RPR frame. Likewise, when a station copies an RPR frame from the ring, the station removes the RPR header from the RPR frame and sends the corresponding RPR payload, which is the Ethernet frame, to the Ethernet traffic.

To transmit a frame from one RPR station to another on the RPR ring, RPR processing in the RPR station encapsulates the frame with an RPR header and adds the newly formed RPR frame to the ring. A station may flood the RPR frame to all other stations on the ring by setting information in the RPR header to indicate that the frame is to be flooded. While the RPR frame traverses the ring, it encounters other RPR stations.

At a given station, the destination MAC address of the RPR header is examined. If the destination address of the frame's RPR header is the same as the station's address and the frame is not indicated as being flooded, then the frame is copied without being forwarded to the next station on the ring. On the other hand, if the destination address of the RPR header is different from the station's address and the frame is not indicated as being flooded, then the frame is forwarded to the next station on the ring. However, if the frame is indicated as being flooded, then the frame is copied before being forwarded to the next station on the ring. To prevent a flooded frame from endlessly traveling around the ring, the station also examines the source address of the RPR header. If the source address is the same as the station's address, then the frame is dropped, thus, preventing an infinite loop.

When an RPR station receives a non-flooded RPR frame and recognizes the destination address, it removes the RPR frame completely from the ring, unlike in the case of flooded frames, which simply copy the contents of the frame and let the frame traverse the rest of the ring. When the receiving station removes the RPR frame from the ring, the bandwidth otherwise consumed by the RPR frame is available for use by other RPR stations. This is known as spatial reuse. It should be noted that an RPR station may implement spatial reuse if the destination of the frame is one of the RPR stations, otherwise, the station must flood the frame on the ring.

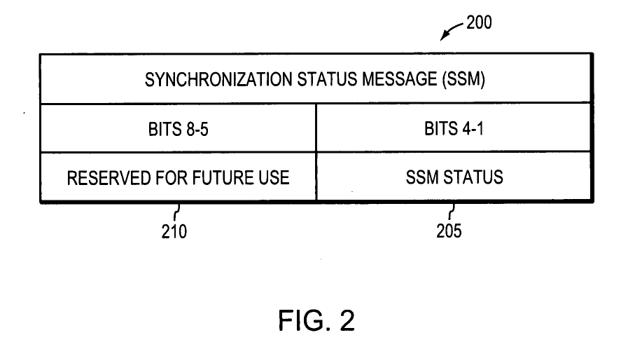

FIG. 2 is a diagram illustrating a Synchronization Status Messaging (SSM) message format 200, according to an embodiment of the present invention. The SSM message is 8 bits in length (one byte) with an SSM status included in the four least significant bits (bits 4-1) 205 of the message. The four most significant bits (bits 8-5) 210 of the message are reserved. It should be noted that this and other example embodiments of the invention are not restricted to the number of example bits listed in this paragraph.

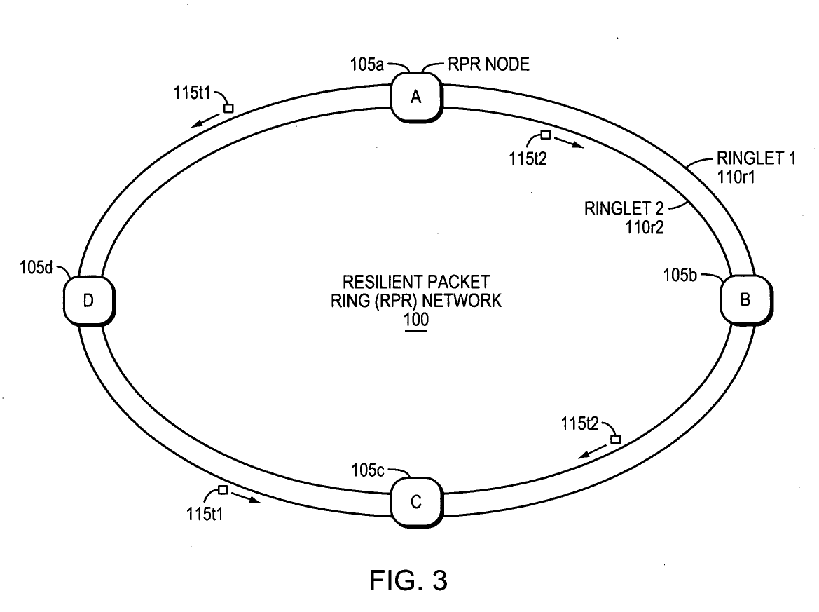

FIG. 3 is a network diagram illustrating distributing timing in an RPR network, according to an embodiment of the present invention. In this example, RPR Node A 105a distributes timing information to other nodes on the RPR ring 100 by generating two SSM messages 115t1, 115t2 to be sent to Node A's 105a two adjacent neighbor nodes, Node B 105b and Node D 105d. In sending the timing messages 115t1, 115t2, Node A 105a encodes each SSM message into an IEEE 802.3ah OAM packet according to ITU G.8261. It should be noted that an entire byte (8 bits) of the IEEE 802.3ah OAM packet is used for including the SSM message, with the least significant half of the byte containing the SSM message and the most significant half unused, but reserved for SSM capability.

In addition to encoding the SSM message in the IEEE 802.3ah OAM packet 115t1, 115t2, Node A 105a also encodes a particular physical interface identifier (e.g., west or east side for an RPR ring) in the spare bits of the SSM message (i.e., the most significant half of the byte set aside for including the SSM message in the IEEE 802.3ah OAM packet). The physical interface identifier may indicate an actual physical interface to which the message is to be sent, a direction in which the message is to be transmitted, or an RPR station identifier to which the message is to be sent.

Alternatively, since most of the information included in an IEEE 802.3ah OAM packet is encoded using a Type-Length-Value (TLV) format, the physical interface identifier may be encoded in the TLV bytes of the IEEE 802.3ah OAM packet. According to the TLV format, a first byte indicates the type of the information, which is used to instruct a node how to decode the bytes containing the information. A second byte specifies the length of the information, which may be used by a node to skip the information when it is determined that the type cannot be interpreted by the node. The subsequent bytes encode the information itself. Using the TLV format, additional information, such as the physical interface, may be included in an OAM that may be ignored by a node that does not recognize the information type.

RPR Node A 105a encapsulates the IEEE 802.3ah OAM packet in an RPR frame and transmits the RPR frame in the direction specified by the physical interface identifier encoded in the message. In doing so, the node 105a sets the RPR frame's destination address to the MAC address of the neighbor RPR node that is situated in the direction of the physical interface identifier specified in the message, and sets the ringlet identifier of the frame to the ringlet corresponding to the physical interface identifier. The node 105a then forwards the RPR frame 115t1, 115t2, with the IEEE 802.3ah OAM based SSM message encapsulated therein, to the physical interface specified by the physical interface identifier.

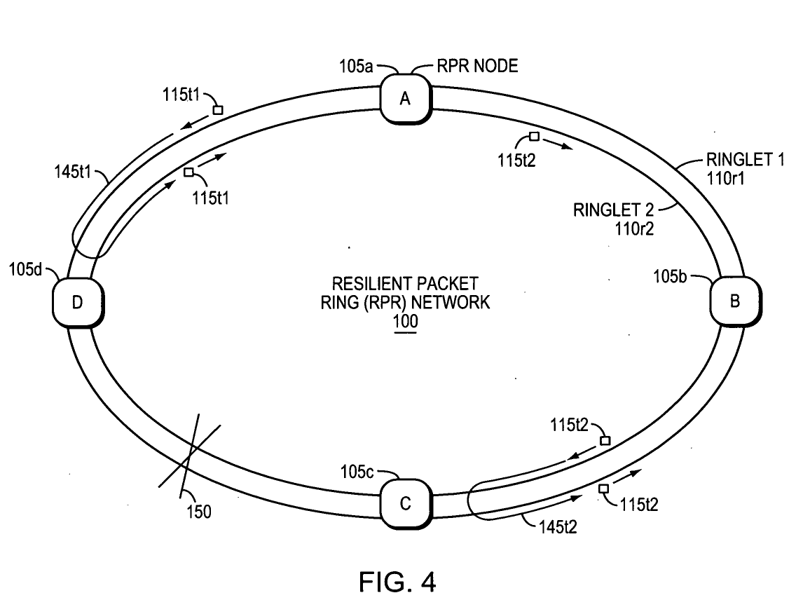

FIG. 4 is a network diagram illustrating distributing timing in an RPR network 100 with a break 150 along a path between two of the network nodes 105c, 105d, according to an embodiment of the present invention. Normally, upon a break 150 in a link of an RPR ring 100, traffic 115t1, 115t2 to be transmitted on the broken link is transmitted in the other direction around the ring 145t1, 145t2 (i.e., transmitted along a protection route). In the case of timing messages, however, it is not desired that the timing messages be transmitted along the protection routes of the RPR ring 100. Therefore, protection should be disabled for RPR frames that include embedded SSM messages. In the example embodiment, a break 150 in the link connecting Nodes C 105c and D 105d occurs. As a result of the break 150, Node D 105d would normally transmit traffic 115t1 traveling counter-clockwise around the ring 100 on Ringlet 1 110r1 in the other direction 145t1 around the ring 100 (i.e., clockwise around the ring on Ringlet 2 110r2); however, if the traffic 115t1 is a timing message 115t1, then Node D 105d does not transmit the message 115t1 in the other direction 145t1 because RPR protection is disabled for the message 115t1. Similarly, as a result of the break 150, Node C 105c would normally transmit traffic 115t2 traveling clockwise around the ring 100 on Ringlet 2 110r2 in the other direction 145t2 around the ring 100 (i.e., counter-clockwise around the ring on Ringlet 1 110r1); however, if the traffic 115t2 is a timing message 115t2, then Node C 105c does not transmit the message 115t2 in the other direction 145t2 because RPR protection is disabled for the message 115t2.

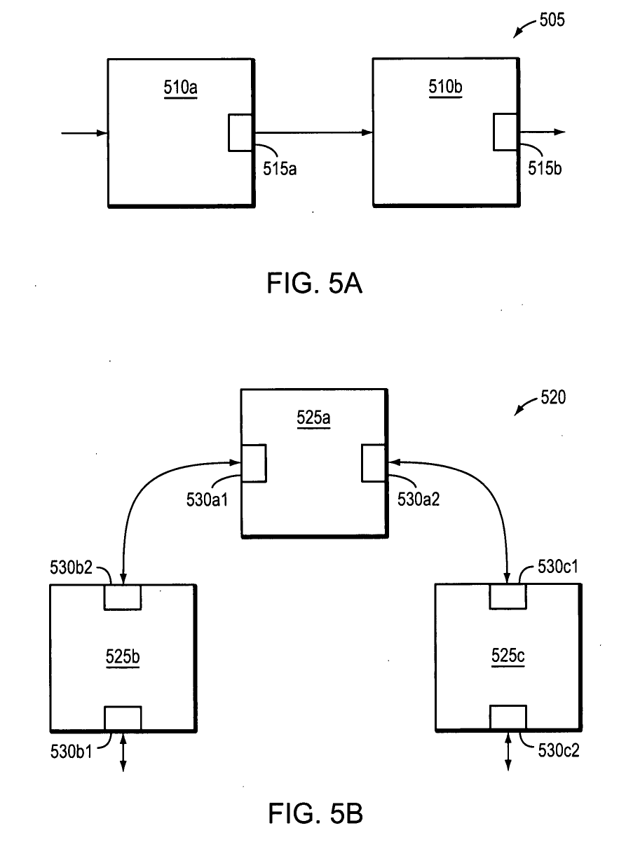

FIG. 5A is a block diagram 505 illustrating interfaces 515a, 515b of nodes 510a, 510b along a path in an Ethernet network. Each node 510a, 510b along the path has only one interface (interface 515a for node 510a and interface 515b for node 510b) over which the node 510a, 510b transmits an SSM message. There is no need to specify the direction of the message since the SSM messages travel in only one direction.

FIG. 5B is a block diagram 520 illustrating interfaces 530a1, 530a2, 530b1, 530b2, 530c1, 530c2 of RPR nodes 525a, 525b, 525c along paths in an RPR network. Each node 525a, 525b, 525c in the ring has two interfaces (interfaces 530a1, 530a2 for node 525a, interfaces 530b1, 530b2 for node 525b, and interfaces 530c1, 530c2 for node 525c) over which the node transmits SSM messages. Since different SSM messages are transmitted in different directions around the ring, the direction of each message is encoded in either spare bits of the SSM message or in Type-Length-Value (TLV) bytes of an encapsulating 802.3ah OAM message.

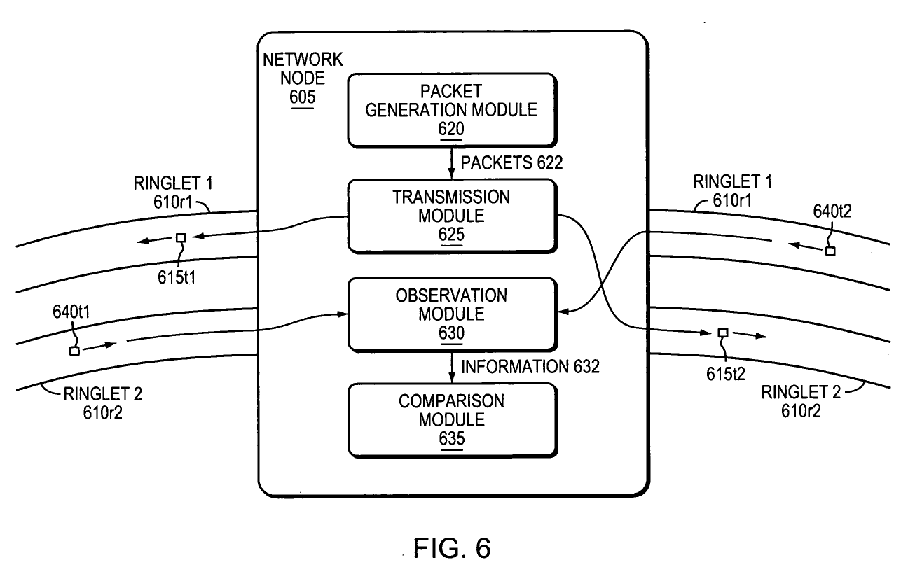

FIG. 6 is a detailed block diagram illustrating a network node 605 in a synchronous RPR network, according to an embodiment of the present invention. In this example, a packet generation module 620 generates packets 622 to distribute timing information over an RPR ring. The packet generation module 620 encodes SSM timing messages into IEEE 802.3ah OAM packets 622 based on ITU G.8261. The packet generation module 620 encodes physical interface identifiers in the packets 622 as well to specify the direction that the node 605 transmits each packet 622 around the RPR ring. These physical interface identifiers are stored in either the spare bits of the SSM timing message (e.g. the four left-most, or most significant, bits of the SSM message) or in the TLV bytes of the IEEE 802.3ah OAM packet 622. A transmission module 625 transmits the packets 615t1, 615t2 in the directions specified by the physical interface identifiers encoded in the packets 622.

An observation module 630 observes information 632 encoded in incoming packets 640t1, 640t2 specifying timing quality and direction of the messages 640t1, 640t2. A comparison module 635 compares the timing information 632 observed in the packets 640t1, 640t2 to determine which timing information 632 to use for clock timing, and selects the best timing reference to use for timing in the node 605.

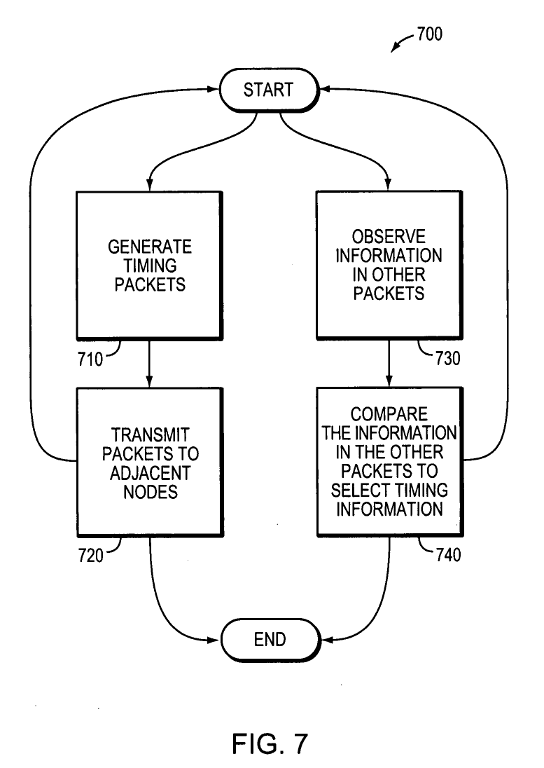

FIG. 7 is a flow diagram 700 illustrating generating, transmitting, observing, and comparing of timing information in a synchronous RPR network, according to an embodiment of the present invention. According to this example, packets used for distributing timing information over an RPR ring are generated by encoding SSM messages into IEEE 802.3ah OAM packets based on ITU G.8261 (710). Physical interface identifiers are also encoded in the messages to specify the direction that each message is to be transmitted around the RPR ring (710). These physical interface identifiers are stored in either the spare bits of the SSM timing message (e.g. the four left-most bits) or in the TLV bytes of the IEEE 802.3ah OAM packet. The packets are then transmitted in the directions specified by the physical interface identifiers encoded in the messages (720). In addition to transmitting timing messages, the example embodiment observes information encoded in incoming packets specifying timing quality and direction of the messages (730). The observed information is then compared to determine which timing information to use for clock timing, and the best timing reference to use for timing is selected (740). It should be noted that the example embodiment may continually generate, transmit, observe, and compare timing information.

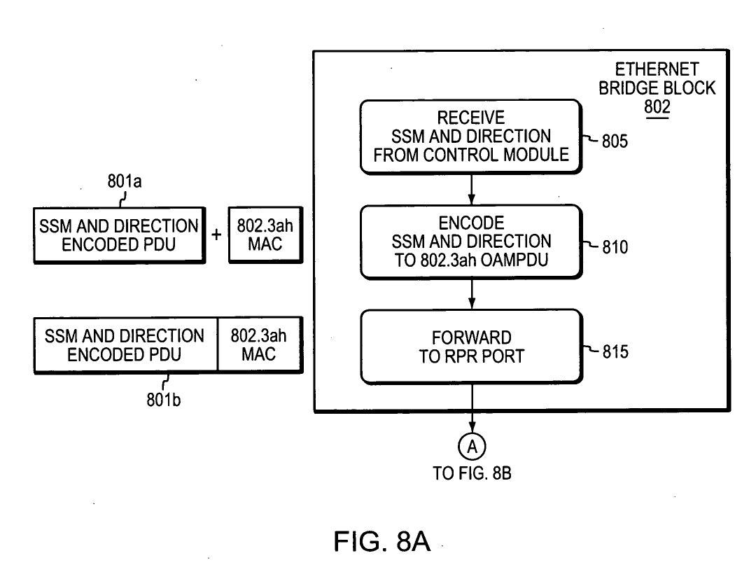

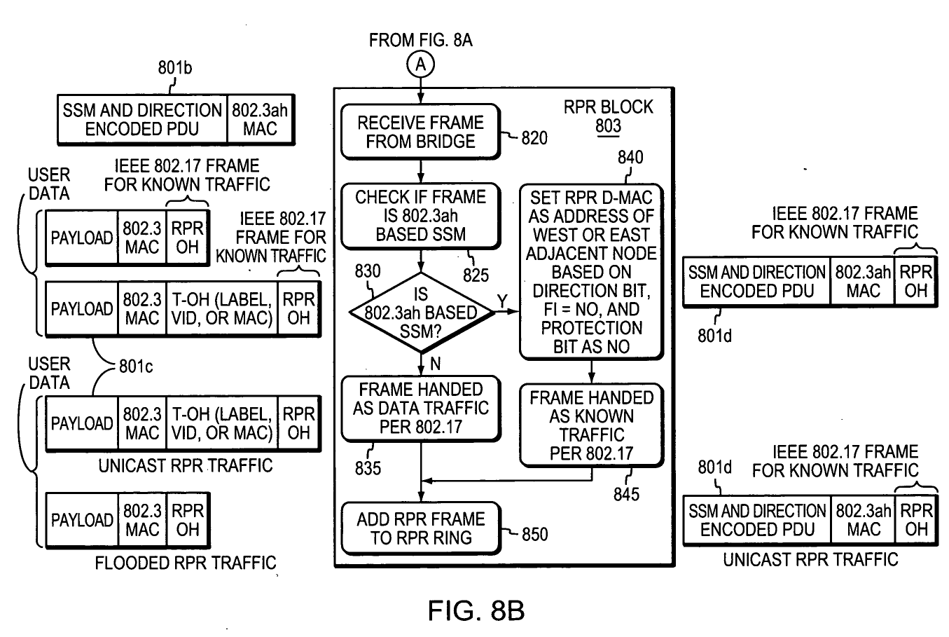

FIGS. 8A and 8B are detailed flow diagrams illustrating generating and transmitting timing messages in a synchronous RPR network, according to an embodiment of the present invention. Upon receiving a Synchronization Status Messaging (SSM) message and a direction of the message 801a from a control module of an RPR station (805), an Ethernet bridge block 802 of the station encodes the SSM message and message direction 801a into an IEEE 802.3ah OAM frame 801b (810) and forwards the generated frame 801b to an RPR port (815).

The IEEE 802.3ah OAM frame 801b is then received at the RPR block 803 (820), which determines whether the frame 801b includes an IEEE 802.3ah OAM based SSM message (825, 830). In the case where a received frame does not include an SSM message, it is handled as data traffic per IEEE 802.17 (835), and the frame is encapsulated in an RPR frame 801c and transmitted on the RPR network by adding the RPR frame 801c to the RPR ring (850). In the case where a received frame does include an IEEE 802.3ah OAM based SSM message, the destination MAC address of the frame is set as either the address of the west or east adjacent node based on the direction that is encoded in the IEEE 802.3 OAM based SSM message (840). Flooding may be disabled for the frame by setting a flood indicator to indicate that the frame should not be flooded, and RPR protection may be disabled for the frame by setting a protection indicator to indicate that protection should not be provided for the frame. The frame including the SSM message is handled as unprotected known traffic per IEEE 802.17 (845) and is encapsulated in an RPR frame 801d and transmitted on the RPR network by adding the RPR frame 801d to the RPR ring (850).

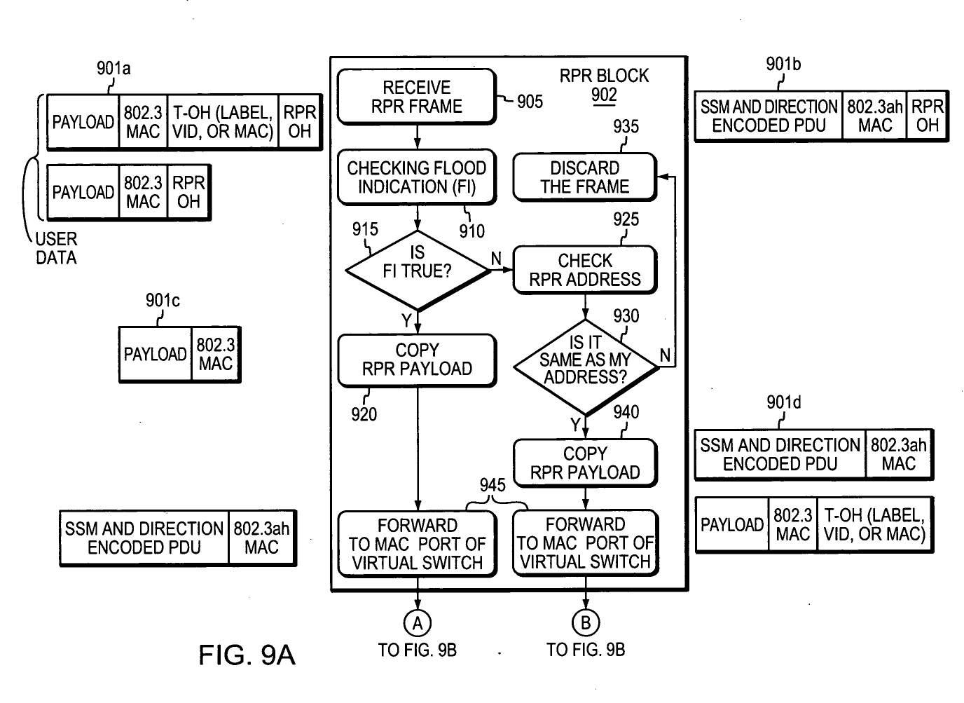

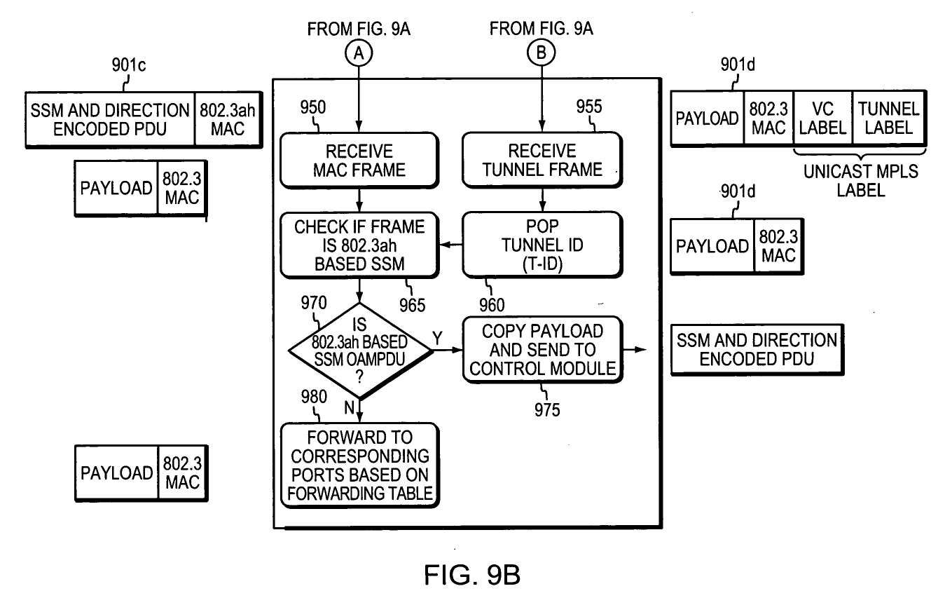

FIGS. 9A and 9B are detailed flow diagrams illustrating observing and comparing timing information in a synchronous RPR network, according to an embodiment of the present invention. Upon receiving an RPR frame 901a, 901b at an RPR block 902 of an RPR station (905), the frame 901a, 901b is checked to determine if flooding has been enabled for the frame 901a, 901b (910, 915). If flooding has been enabled, then the payload 901c, 901d of the RPR frame 901a, 901b is copied (920) and forwarded to a MAC port of the RPR station (945). If flood is not enabled, then the RPR block checks the RPR address of the RPR frame 901a, 901b to determine if it is the same as the RPR station's address (925, 930). If it is not the same, then the RPR frame 901a, 901b is discarded (935). However if the addresses match, the payload 901c, 901d of the RPR frame 901a, 901b is copied (940) and forwarded to the MAC port of the RPR station (945).

The payload 901c, 901d is received (950, 955) and checked to determine whether it is a tunnel frame and whether it includes an IEEE 802.3ah OAM based SSM message (965, 970). If the payload is a tunnel frame 901d, then the tunnel identifier is removed from the frame 901d (955, 960) before making the SSM determination. If the payload 901c, 901d includes an IEEE 802.3ah OAM based SSM message, the payload 901c, 901d is copied and sent to a control module of the RPR station for processing (975); however, if the payload 901c, 901d does not include an IEEE 802.3ah OAM based SSM message, then it is forwarded to one or more ports of the RPR station based on a forwarding table (980).

While this invention has been particularly shown and described with references to example embodiments thereof, it will be understood by those skilled in the art that various changes in form and details may be made therein without departing from the scope of the invention encompassed by the appended claims. For example, while an IEEE 802.3ah OAM frame has been described in the above embodiments for transporting an SSM message over an RPR ring, any similar OAM message, such as OAM messages described in ITU Y.1731, may be used to distribute SSM messages over RPR networks based on the methods and apparatuses described above.

Further, it should be understood that the flow diagrams of FIGS. 7, 8A, 8B, 9A, and 9B are examples that can include more or fewer components, be partitioned into subunits, or be implemented in different combinations. Moreover, the flow diagrams may be implemented in hardware, firmware, or software. If implemented in software, the software may be written in any software language suitable for use in networks and network devices as illustrated in FIGS. 3, 4, and 6 with nodes having interfaces as illustrated in FIG. 5B and traffic including timing messages as illustrated in FIG. 2. The software may be embodied on any form of computer readable medium, such as RAM, ROM, or magnetic or optical disk, and loaded and executed by generic or application specific processor(s).

What is claimed is:

1. A node in a protection packet ring network, comprising:
a packet generation module to generate packets with information embedded in the packets relevant to both selection of timing and an interface to a physical link; and
a transmission module to transmit the packets via respective interfaces to adjacent nodes on the protection packet ring.

2. The node of claim 1 wherein the transmission module disables protection for SSM based packets to prevent transmission of the packets via a protection path associated with a faulty physical link.

3. The node of claim 1 wherein the transmission module determines on which interfaces to transmit the packets by accessing a table associated with a protection layer.

4. The node of claim 1 wherein the information includes a direction indicator and a timing quality indicator.

5. The node of claim 1 wherein the information includes an interface identifier and a timing quality indicator.

6. The node of claim 1 wherein the information includes a station identifier and a timing quality indicator.

7. The node of claim 1 wherein the information includes Synchronization Status Messaging (SSM) information.

8. The node of claim 1 wherein the information is embedded in an overhead section of the packets.

9. The node of claim 1 wherein the packets are operations administration and maintenance (OAM) packets.

10. The node of claim 1 further including:
an observation module to observe information embedded in other packets identifying interfaces to physical links of the adjacent nodes from which the other packets were received; and
a comparison module to compare the information of the other packets to select which timing information included in the packets to use for clock timing in the node.

11. A node in a protection packet ring network, comprising:
an observation module to observe information embedded in packets identifying interfaces to physical links of other nodes from which the packets were received; and
a comparison module to compare the information of the packets to select which timing information included in the packets to use for clock timing in the node.

12. The node of claim 11 wherein the observation module removes resilient packet ring (RPR) identifiers from the packets.

13. A method of distributing timing in a protection packet ring network, comprising:
generating packets with information embedded in the packets relevant to both selection of timing and an interface to a physical link; and
transmitting the packets via respective interfaces to adjacent nodes on the protection packet ring.

14. The method of claim 13 wherein transmitting the packets includes disabling protection for the packets to prevent transmission of the packets via a protection path associated with a faulty physical link.

15. The method of claim 13 wherein transmitting the packets includes determining on which interfaces to transmit the packets by accessing a table associated with a protection layer.

16. The method of claim 13 wherein the information includes a direction indicator and a timing quality indicator.

17. The method of claim 13 wherein the information includes an interface identifier and a timing quality indicator.

18. The method of claim 13 wherein the information includes a station identifier and a timing quality indicator.

19. The method of claim 13 wherein the information includes Synchronization Status Messaging (SSM) information.

20. The method of claim 13 wherein generating the packets includes embedding the information in an overhead section of the packets.

21. The method of claim 13 wherein the packets are operations administration and maintenance (OAM) packets.

22. The method of claim 13 further including:
observing information embedded in other packets identifying interfaces to physical links of the adjacent nodes from which the other packets were received; and
comparing the information of the other packets to select which timing information included in the other packets to use for clock timing.

23. A method of distributing timing in a protection packet ring network, comprising:
observing information embedded in packets identifying interfaces to physical links of nodes from which the packets were received; and
comparing the information of the packets to select which timing information included in the packets to use for clock timing.

24. The method of claim 23 wherein observing information includes removing resilient packet ring (RPR) identifiers from the packets.
